(19) United States
(12) Patent Application Publication
(10) Pub. No.: US 2023/0220164 A1
(43) Pub. Date: Jul. 13, 2023

(54) Heteroleptic Polyhedral Oligomeric Silsesquioxane Compositions and Method

(71) Applicant: Hybrid Plastics, Incorporated, Hattiesburg, MS (US)

(72) Inventors: Joseph D. Lichtenhan, Petal, MS (US); Sukhendu B. Hait, Hattiesburg, MS (US)

(73) Assignee: Hybrid Plastics, Incorporated, Hattiesburg, MS (US)

(21) Appl. No.: 17/910,704

(22) PCT Filed: Mar. 10, 2021
(86) PCT No.: PCT/US2021/021715

§ 371 Date: Sep. 9, 2022

Related U.S. Application Data
(60) Provisional application No. 62/987,702, filed on Mar. 10, 2020.

(51) Int. Cl. C08G 77/06

(52) U.S. Cl. CPC C08G 77/06

(57) ABSTRACT

A single vessel process for producing heteroleptic POSS compositions. The process involves the addition of two or more different organosilanes into a reactor containing a solvent. A base catalyst is added to the reactor to hydrolytically assemble the POSS cage core and statistically distribute the organic groups from the organosilanes around the periphery of the POSS cage core. An acid is then added to neutralize or quench the base catalyst. The product is washed and the remaining solvent is removed to recover the heteroleptic POSS. In some alternate embodiments, the product is filtered to recover the heteroleptic POSS. The heteroleptic POSS compositions produced by this process are able to provide an envelope of desirable effects. The heteroleptic POSS compositions may be used as additives for optimizing the performance attributes of coatings, biological materials, thermoplastics, thermoset, and gel polymer systems. The process also produces homoleptic POSS compositions with improved physical characteristics.

### CROSS REFERENCE TO RELATED APPLICATION

This application is a national stage application under 35 USC § 371 of PCT/US2021/021715, filed on Mar. 10, 2021, which claims priority to U.S. Provisional Patent Application No. 62/987,702, filed on Mar. 10, 2020, both of which are incorporated herein by reference in their entirety.

### BACKGROUND

Polyhedral oligomeric silsesquioxanes (POSS) are a family of molecules that consist of a silica-like core surrounded by a shell of organic groups. The chemical composition of POSS is a hybrid intermediate between that of silica (SiO₂) and silicone (R₂SiO). The key purpose of POSS compositions is to create hybrid materials that are easy to process like polymers, yet possess the characteristics of high-use temperature and oxidation resistance like ceramics. These nanostructures have the empirical formula Rₙ(SiO_{1.5})ₙ, where R is a hydrogen atom or an organic functional group such as an alkyl, alkylene, acrylate, hydroxyl, or epoxide unit. Unlike silica or modified clays, each POSS molecule contains covalently bonded reactive functionalities suitable for polymerization or grafting POSS monomers to polymer chains, as well as nonreactive organic functionalities for solubility and compatibility of the POSS segments with the various polymer systems.

Heteroleptic POSS compositions containing two or more different organic groups attached to a single POSS cage core are distributed in a statically random manner. Heteroleptic compositions are desirable because they afford POSS chemical additives the ability to provide a broader envelope of physical effects in a material formulation. Because of their ability to provide an envelope of desirable effects, heteroleptic additives can be used to optimize the performance attributes of coatings, biological materials, thermoplastics, thermoset and gel polymer systems.

Heteroleptic POSS compositions, however, have proven to be difficult to manufacture in an efficient manner with the desired purity, and the available compositional range has been limited using the prior art methods. For example, U.S. Pat. No. 6,972,312 to Lichtenhan et. al. discloses an example of a single heteroleptic POSS composition containing cyclohexyl and cyclohexenyl groups attached to the same cage. The heteroleptic POSS was manufactured using a multi-stage process, requiring the use of two pre-formed POSS cages. An acid catalysis was used to first manufacture a POSS resin that was subsequently isolated. In a second step the resin was converted into the heteroleptic cage using a base-catalyzed redistribution reaction.

Corner capping and silylation methods also have been extensively described to render heteroleptic POSS. Most notable is U.S. Pat. No. 6,972,270. Both methods of corner capping and corner silylation require the use of a preformed and isolated POSS silanol. Consequently, both of these approaches are also limited by the ability to isolate a stable silanol intermediate. To date the only available trisilanol POSS contain nonfunctional R groups such as ethyl, chloropropyl, i-butyl, cyclopentyl, cyclohexyl, phenyl, norbornyl, i-octyl. Thus the available compositional range is limited. Furthermore, the corner capping process is geometrically limited to introducing only one hetero organic functionality onto a POSS cage. Similarly, the exhaustive silylation process is limited to adding three hetrofunctional organic groups onto a cage. However, these groups are geometrically limited to fixed positions around one vertice and cannot be incorporated otherwise nor in a statistical manner.

U.S. Pat. No. 6,972,270 to Lichtenhan et. al also teaches a single vessel process for the assembly of homoleptic POSS cages. The process involves eight sequential steps. Additionally, the homoleptic POSS products are generally brown colored and contain traces of salt and acid. Therefore, the homoleptic POSS resulting from this process require a secondary step of purification to improve their quality and appearance. The number of steps in the process and the color and trace impurities in the homoleptic POSS product are undesirable for economical bulk scale manufacture.

A more efficient manufacturing method for making heteroleptic POSS compositions is needed. Furthermore, a greater diversity of potential heteroleptic POSS compositions is needed to expand the applications and available property enhancements provided by POSS compositions.

### SUMMARY

Disclosed herein are new heteroleptic POSS compositions prepared through a new and simplified single vessel manufacturing method. Efficient and high yielding, economical reactions are always desired throughout chemistry. The reduction of steps and elimination of need to isolate intermediate products are the key advancements that led to this new method. While developing the simplified single vessel process, it was also discovered that the new process enabled the manufacture of POSS compositions that were not possible using the prior art processes. These new compositions are referred to as heteroleptic POSS because they contain more than one type and number of organic group (R) on a single POSS cage core. The resulting heteroleptic POSS compositions provide discernable advantages over prior POSS in terms of their ability to be utilized as additives to enhance the physical properties of a wide range of material types.

This single vessel method for producing heteroleptic POSS compositions does not require isolation of a POSS intermediate, which reduces manufacturing steps and time and also improves overall product yield. As shown in FIG. 1, the new single vessel method involves the addition of two or more different organosilanes into a reactor containing a solvent, followed by the addition of a base catalyst to hydrolytically assemble the cage core and statistically distribute the organic groups from the organosilanes around the periphery of the cage core. The base catalyst is then neutralized through the addition of acid, and the product is washed and obtained by removing the solvent. The process is carried out in a single reactor and is essentially a one operational step process.

The single vessel process for manufacturing heteroleptic POSS can also be used to manufacture homoleptic POSS compositions having improved physical characteristics. Both of the newly discovered processes require only six total steps with the option to use a soluble acid or an insoluble acid in the neutralizing step (i.e., the acid quenching step).

The single vessel process provides key economical benefits over the multi-stage method described in U.S. Pat. No. 6,972,270 due to the reduction in the number of steps and the elimination of trace amounts of salt, acid, and base in the product in the new process. One embodiment of the new process also eliminates the use of water and wash solvent in addition to maintaining product purity.

The heteroleptic POSS compositions produced using the new processes described herein can be considered “smart” additives because they provide an envelope of effects due to the incorporation of a range of organic functionality on the same POSS core. For example, POSS cages that contain two different types of polymerizable functionality (R′) provide dual cure (crosslinking) capability to formulations. Alternately, POSS cages that contain one polymerizable functionality and one or more special functionality (R″) (e.g., a dispersion functionality) provide simultaneous crosslinking and dispersion capability. Similarly, POSS cages that contain a polymerizable functionality and a plasticization functionality (R′″) provide for nonmigrating plasticizers. Finally, heteroleptic POSS compositions are also described that contain functionalities that are nonpolymerizable (R′″ and R″) yet provide reinforcement, dispersion, emulsion, and plasticization while simultaneously providing the ability to compatibilize disparate ingredients.

### BRIEF DESCRIPTION OF THE DRAWINGS

FIG. 1 is a schematic illustration of a single vessel process for producing heteroleptic POSS compositions.

FIG. 2 is an illustration of the stoichiometrically controlled distribution of two organic groups on an octameric heteroleptic POSS composition.

FIG. 3 is an illustration of the POSS cage products produced in the single vessel process, including octameric, decameric, and dodecameric POSS cage sizes.

FIG. 4 is a graphical representation of the viscosity of homoleptic POSS compositions, a physical mixture of two homoleptic POSS compositions, and a heteroleptic POSS composition.

FIG. 5 is a graphical representation of the Shore D hardness of 50/50 glycidyl/methacryl heteroleptic POSS using free radical curing, cationic curing, and dual curing methods.

FIG. 6 is a comparison of the appearance of free radial cured plaques for (a) a 50/50 mixture of glycidyl EP0409 homoleptic POSS and methacryl MA0735 homoleptic POSS, and (b) 50/50 glycidyl/methacryl heteroleptic POSS.

FIG. 7 is a comparison of the appearance of cationic cured plaques for (a) a 70/30 mixture of glycidyl homoleptic POSS and methacryl homoleptic POSS, and (b) the 70/30 mixture after addition of glycidyl/methacryl heteroleptic POSS.

FIG. 8 is a graphical representation of the surface energy in dynes (mN/M) of a 50/50 glycidyl/methacryl heteroleptic POSS composition and a 50/50 physical mixture of homoleptic POSS compositions after free radical, cationic, and dual cure methods of curing.

### DETAILED DESCRIPTION OF THE PREFERRED EMBODIMENTS

For the purposes of this disclosure, the following definition for representations of polyhedral oligomeric silsesquioxane (POSS) nanostructural formulas is made. All POSS contain an organic R group. The organic R group is carried over from the organosilane feedstocks utilized in the method of manufacture of POSS. Table 1 provides three categories of POSS cage R group types based on the chemical effect of each R group. For example, all R′ groups are capable of reactive chemistry, all R″ groups are chemically nonreactive but serve a special purpose such as providing a surface energy, dispersion, or biological effect, and R′″ groups are chemically nonreactive and serve a purpose such as hydrophobicity, thermal stability, chemical compatibility, or plasticization.

TABLE 1
Three categories of organic R groups in heteroleptic POSS

| R′ (Reactive Groups) | R″ (Nonreactive Special Purpose Groups) | R′″ (Nonreactive Groups) |
|---|---|---|
| Derived from organosilane | Derived from organosilane | Derived from organosilane |
| R′—SiX₃ | R″—SiX₃ | R′″—SiX₃ |
| where X = OCH₃, or OCH₂CH₃ | where X = OCH₃, or OCH₂CH₃ | where X = OCH₃, or OCH₂CH₃ |
| Epoxy | Polyether (PEG and higher ether oligomers) | Aliphatic (C₁-C₃₂) |
| (contains one or more cyclic ethers) | | |
| Amino | Fluorinate Aliphatic (C₁-C₃₂) | Aromatic (phenyl through |
| (contains one or more N—H bond) | | polyaromatic) |
| Vinyl Olefin | Fluorinated Aromatic (phenyl through | Silicone |
| | polyaromatic) | |
| Cyclic Olefin | Phosphorus (contains one or more C—P | |
| | bonds or C—O—P bonds) | |
| Bicyclic Olefin | Ammonium (contains one or more | |
| | quaternary N atoms) | |
| Allylic Olefin | | |
| Methacrylic | | |
| Acrylic | | |
| Styrenic | | |
| Sulfur | | |
| (contains one or more C—S bond) | | |
| Silane | | |
| (contains one or more Si—H bond) | | |
| Acid | | |
| (contains one or more C(═O)OH) | | |
| Aldehyde | | |
| (contains one or more C(═O)H) | | |
| Alcohol | | |
| (contains one or more C—OH bond) | | |
| Azide | | |
| (contains one or more N₃) | | |
| Aziridine | | |
| (contains one or more cyclized nitrogen) | | |
| Nitrile | | |
| (contains one or more —CN) | | |
| Isocyanate | | |
| (contains one or more —NCO) | | |
| Halide | | |
| (contains one or more C—Cl/Br/I bonds) | | |

In addition to the organic R group, POSS compositions contain polycyclic structural features stemming from the geometric arrangement of their silsesquioxane SiO_{1.5} structural backbone. These structural features are important as they impact properties such as solubility, physical form (solid, wax, liquid), melting point, surface area, and volume.

POSS compositions are represented by the following formulas:
[(RSiO_{1.5})ₙ]Σ# for homoleptic cage compositions containing equivalent R groups.
[(R¹SiO_{1.5})ₙ(R²SiO_{1.5})ₘ]Σ# for heteroleptic compositions with two different R groups, R¹ and R². Compositions including two or more R groups (e.g., R¹, R², R³, R⁴, etc.) on the same silsequioxane nanostructure cage backbone are envisioned. The number of different R groups in the composition is between two and the number of Si atoms in the POSS cage structure. Each R group may be selected from the R′, R″, and R′″ groups listed in Table 1.
   The symbol Σ indicates that the composition forms a nanostructure, and the symbol # refers to the number of silicon atoms contained within the nanostructure. The value for # is the sum of m+n. It should be noted that Σ# in this context is not to be interpreted as a multiplier for determining stoichiometry. Instead, Σ# merely describes the overall nanostructural characteristics of the POSS system (i.e., cage size) and composition.

Homoleptic POSS compositions, which are represented by the formula [(R¹SiO_{1.5})ₙ]Σ#, are closed cage compositions for which all R groups are the same. Heteroleptic POSS compositions, which are represented by the formula [(R¹SiO_{1.5})ₙ(R²SiO_{1.5})ₘ]Σ#, contain more than one type of R group on the same molecule. For octameric cages, up to eight different R groups can reside on the same molecule. For decameric cages and dodecameric cages, up to ten and twelve different R groups, respectively, can reside on the same molecule.

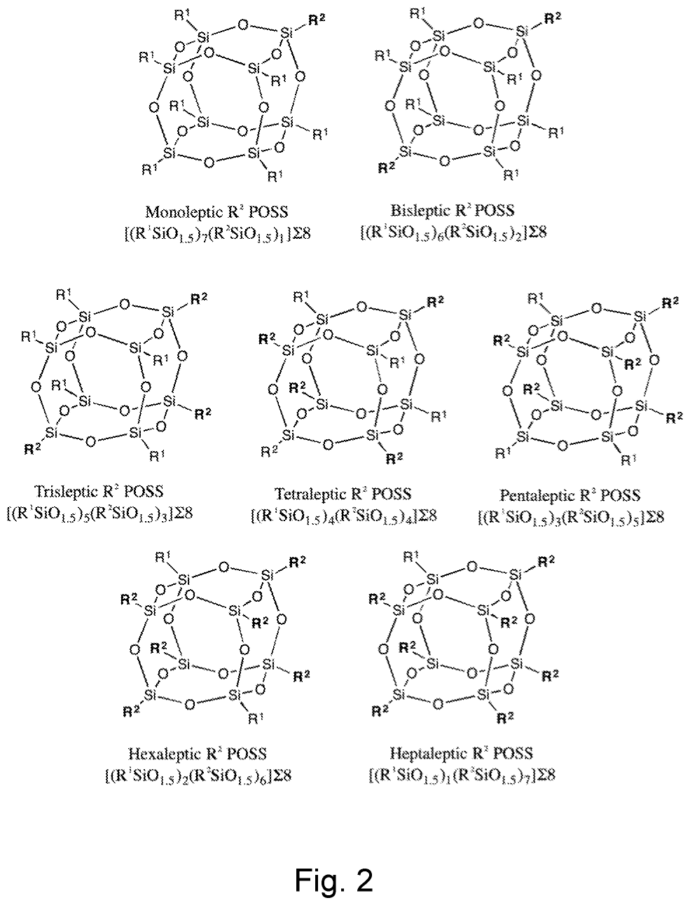

A representative example of a lepticity sequence for two different R groups, R¹ and R², contained on an octameric POSS heteroleptic cage composition is shown in FIG. 2. As used herein, “leptcity” means types of different organic groups.

As is typical with chemical processes there are a number of variables that can be used to control the purity, selectivity, rate and mechanism of any process. Variables influencing the process of manufacturing heteroleptic POSS from organosilanes include but are not be limited to the following: stoichiometry of organosilane feedstocks, molar concentration, rates of addition, sequence of addition, chemical class of base, temperature, duration of reaction time, volatilization and removal of reaction by products during reaction, the use of surfactants, coagents, and the presence of a catalyst.

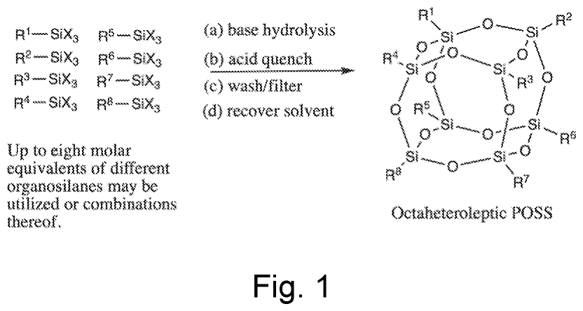

FIG. 1 provides a schematic illustration of a single-vessel process for producing heteroleptic POSS compositions. First, two or more organosilane coupling agents and a hydroxide base are dissolved or suspended in a solvent, which is represented by step (a) of FIG. 1. The concentration of the two or more organosilane coupling agents in the reaction vessel may be 0.5-8 moles/liter, or any subrange therein, and preferably 1-2 moles/liter, or any subrange therein. The hydroxide base is selected from organic hydroxides, alkali hydroxides, and alkaline earth hydroxides. The concentration of the hydroxide base in the reaction vessel may be 0.01-2.5 mole % of the organosilane concentration, or any subrange therein. The solvent is a technical grade solvent suitable for solubilizing the POSS. Suitable solvents include, but are not limited to, cyclohexane, tetrahydrofuran, ethyl acetate, chloroform, dichloromethane, methylethyl ketone, methyisobutyl ketone, acetone, toluene, hexane, and N-methyl-2-pyrrolidone. The reaction mixture is stirred for a time period of 4-72 hours, or any subrange therein. Under non-heated conditions, the reaction mixture is stirred for 24-72 hours, or any subrange therein. Preferably, the reaction mixture may be stirred for a time period of about 48 hours. The reaction mixture may be heated to a temperature of 20-120° C., preferably 24-60° C.

Upon conversion of the organosilane into POSS, the reaction is stopped by quenching the base through use of an acid, which is represented by step (b) of FIG. 1. A sufficient amount of acid is added to neutralize the reaction mixture to a pH value in the range of 5-7, or any subrange therein. The acid used in the acid quenching step may be a soluble acid or an insoluble acid. Suitable soluble organic acids include, but are not limited to, acetic, citric, hydrochloric, phosphoric, sulfuric, formic, and nitric acid. Alternately, a suitable insoluble acid may be used in the acid quenching step, including, but are not limited to, acidic-alumina, -silicon, -iron and related metal oxides and nonmetal oxides.

Step (c) illustrated in FIG. 1 includes a washing or filtration procedure based on the type of acid used in the acid quenching step. Table 2 below lists the steps of the single vessel process of preparing heteroleptic POSS using a soluble acid in Process 1 and the steps of the process using an insoluble acid in Process 2.

TABLE 2
Six step processes for preparation of
homoleptic and heteroleptic POSS cages

| Step | New Process 1 | Step | New Process 2 |
|---|---|---|---|
| 1 | Charge reactor with | 1 | Charge reactor with |
| | solvent, silane, base. | | solvent, silane, base. |
| 2 | Quench using soluble acid. | 2 | Quench using insoluble |
| | | | acid |
| 3 | Add non-POSS solvent and | 3 | Filter insoluble salt. |
| | POSS solvent to wash and | | |
| | separate product. | | |
| 4 | Drain bottom water layer | 4 | Add dissolved product |
| | containing dissolved salt | | back to reactor |
| | away from solvent | | |
| | dissolved product. | | |
| 5 | Remove solvent. | 5 | Remove solvent. |
| 6 | Package product from | 6 | Package product from |
| | vessel. | | vessel. |

In Process 1, step (c) includes adding non-POSS solvent to the reaction vessel to dissolve the salt. Also, a POSS-solubilizing solvent (also referred to as a POSS solvent) is added to dissolve the POSS product and phase separate it from the non-POSS solvent. POSS-solubilizing solvents suitable for Process 1 include, but are not limited to, cyclohexane, tetrahydrofuran, ethyl acetate, chloroform, dichloromethane, methyl ethyl ketone, methyl isobutyl ketone acetone, toluene, and hexane. Non-POSS solvents suitable for Process 1 include, but are not limited to, water, methanol, ethanol, hexane, and acetonitrile. The amount of the non-POSS solvent added may be 1.5 to 2.5 times the molar concentration of the organosilane feed, or any subrange therein.

In contrast, Process 2 is advantageous in that it utilizes an insoluble acid that naturally separates the salt from the reaction solvent. The salt is easily removed through filtration of the suspended salt using a bag filter or similar device in step (c).

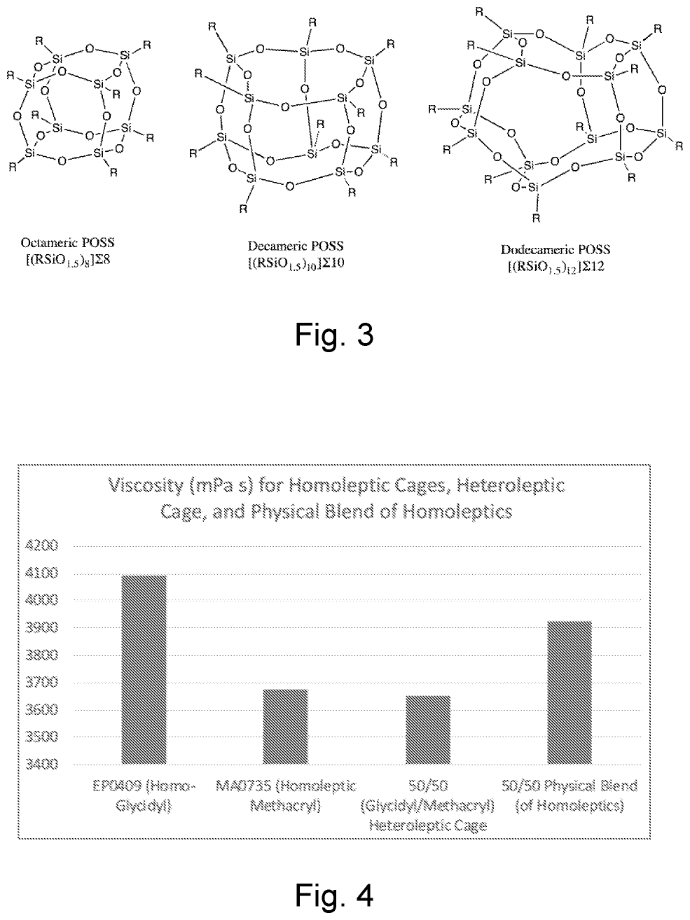

It was discovered that both single vessel Process 1 and Process 2 result in compositions that are best described as mixtures of cage-core sizes. Gel permeation chromatography, and NMR verify the cage sizes range from eight silicon to twelve silicon atoms in the framework of the POSS product as shown in FIG. 3. A distribution of cage sizes of eight, ten, and twelve silicon atoms is often desirable to enhance solubility of the final product and in some cases to decrease the melting point.

An advantageous aspect of the new single vessel method is that it eliminates the use of chlorinated silanes (X═Cl) and is most amenable to use of methoxy or ethoxy silanes (X═OCH3 or OCH2CH3). The elimination of chlorosilanes enables the manufacture of heteroleptic POSS under mild and noncorrosive conditions.

Additionally, the new single vessel method enables the ability to utilize mixtures of different organosilanes simultaneously as feedstocks. This results in a greater diversity of organic R groups that can be attached to the same POSS cage molecule during a single manufacturing step. The diversity of organic group attachment to the cage core includes incorporation of organic groups that would be incompatible if they were not attached to the cage core (e.g., hydrophilic vs hydrophobic).

The new single vessel method can be used to manufacture a wide variety of heteroleptic POSS compositions by simply varying the type of organosilane feed used and its molar equivalent added to the reactor. FIG. 2 illustrates, for an octameric POSS cage, the statistical range of heteroleptic POSS compositions resulting from control of molar stoichiometry from 1:7 to 7:1 between two different organosilanes R1 and R2. This range of heteroleptic POSS compositions was not previously accessible until the development of this new single vessel method. The degree to which different types of R groups can be incorporated is primarily controlled by reaction stoichiometry.

Both embodiments of the single vessel process for producing heteroleptic POSS (i.e., Processes 1 and 2) can also be used to manufacture homoleptic POSS compositions with improved physical characteristics. Both Processes 1 and 2 provide a greater quality homoleptic POSS product than the product made in prior art single vessel processes for making homoleptic POSS cages. For example, the homoleptic POSS compositions of the formula [(3-methacryloxypropylSiO_{1.5})n]_{Σ#} and [(2-(3,4-epoxcyclohexyl)ethylSiO_{1.5})n]_{Σ#} are described in U.S. Pat. No. 6,972,270 as clear brown products. However, both of the new processes described in Table 2 produce these POSS compositions in the form of colorless or straw-colored clear liquids, thus eliminating the purification step required in the prior art method. The POSS compositions with low color are more desirable for use in optical coatings than highly colored additives.

The following synthetic methods provide a process for the preparation of homoleptic and heteroleptic POSS which are primarily comprised of cage sizes (Σ#) ranging from 8-12 and minor amounts of structurally ill-defined resin. These methods are intentionally desired to manufacture POSS with a range of cage sizes to render products with high solubility, compatibility, and reduced melting points.

### Example of Improved Quality Homoleptic Cage Synthesis

The following will serve an example for the single vessel method of manufacturing homoleptic POSS using methoxy organosilanes.

### Synthesis of (MethacrylpropylSiO_{1.5})n]Σ#

3-methacrylpropyl trimethoxy silane (99.8 g) and tetrahydrofuran (191 g) and acetone (170 g) and water 10.96 g were added to a reactor. After 10 min, 1 g of tetramethyl ammonium hydroxide was added and stirred for 48 hours at room temperature. The reaction was then stopped (quenched) by adding an amount of concentrated hydrochloric acid sufficient to neutralize the reaction mixture to a pH in the range of 5-7, or any subrange therein. Ethyl acetate (32.4 g), water (275 g), and cyclohexane (50 g) were added and stirred for 1 hour. Stirring was stopped and a phase separation was allowed to occur. The top layer was washed with DI water, and the solvent was removed. The homoleptic POSS product was a clear colorless liquid. The yield of (MethacrylpropylSiO_{1.5})ₙΣΣ# was 99%.

### Examples of Heteroleptic Cage Synthesis

The following will serve as examples for the single vessel method of manufacturing heteroleptic POSS using methoxy organosilanes.

### Synthesis of [(GlycidylpropylSiO_{1.5})ₘ(MethacrylpropylSiO_{1.5})n]Σ#

3-glycidoxypropyl trimethoxy silane (430.61 g), 3-methacrylpropyl trimethoxy silane (151 g), and water (65.68 g) were mixed in a solubilizing solvent (1,800 g) with stirring. After 10 minutes, tetramethyl ammonium hydroxide (10 g of 25 wt. % in water) was added and stirred 48 hours. Citric acid (8 g) was then added and stirred for 1 hour. Ethyl acetate (1000 g), water (1000 g) were added and stirred for 1 hour. Stirring was stopped and a phase separation was allowed to occur. The top layer was washed with DI water, and the solvent was removed. The heteroleptic POSS product was a clear colorless liquid. The yield of [(GlycidylpropylSiO_{1.5})m(MethacrylpropylSiO_{1.5})n]Σ# was 97%.

### Synthesis of [(PEGSiO_{1.5})m(EpoxycylohexylethylSiO_{1.5})n]Σ#

PEGsilane (205.51 g), epoxycyclohexylethyl trimethoxy silane (224.21 g), solubilizing solvent (1,700 g), and water (45.2 g) were mixed with stirring for 10 minutes. Tetramethyl ammonium hydroxide (5 g of 25 wt. % in water) was then added and the mixture was stirred for 48 hours. Citric acid (2.63 g) was then added and allowed to stir for 1 hour. Solvent was then removed and the liquid product was filtered. The heteroleptic POSS product was a clear, pale yellow liquid. The yield of [(PEGSiO_{1.5})m(EpoxycylohexylethylSiO_{1.5})n]Σ# was 99%.

### Synthesis of [(PEGSiO_{1.5})m(heptadecafluoroSiO_{1.5})n]Σ#

PEG silane (32.37 g), heptadecafluoro 1, 1, 2, 2,-trimethoxy silane (2.77 g), solubilizing solvent (160 g), and water (3.66 g) were mixed together in a 500 ml round bottom flask with stirring. After 10 minutes, tetramethyl ammonium hydroxide (0.96 g of 25 wt % in water) was added and stirred for 48 hrs. Citric acid (0.253 g) was added and stirred for 1 hour. The solvent was removed and the liquid product was filtered. The heteroleptic POSS product was a clear, pale yellow liquid. The yield of [(PEGSiO_{1.5})m(heptadecafluoroSiO_{1.5})n]Σ# was 95%.

### Synthesis of [(EpoxyCyclohexylethylSiO_{1.5})m(i-OctylSiO_{1.5})n]Σ#

2-(3,4-epoxycyclohexyl)ethyl trimethoxysilane (224.2 g), i-octyl trimethoxysilane (74.9 g) and water (33 g) were mixed in a solubilizing solvent (900 g) with stirring. After 10 minutes, tetramethyl ammonium hydroxide (50 g, 25 wt. % in water) was added and stirred for 48 hours. Citric acid (2.69 g) was added to the reaction and stirred for 1 hour. Ethyl acetate (550 g) and water (550 g) were added to the reactor and stirred for 1 hour. After phase separation occurred, the top layer was washed with water, solvent is removed and the product is dried. The product was a clear colorless liquid. The yield of [(EpoxyCyclohexylethylSiO_{1.5})m(i-Octyl SiO_{1.5})n]Σ# was 99%.

### Synthesis of [(MethacrylpropyllSiO_{1.5})ₘ(i-OctylSiO_{1.5})ₙ(TrifuloropropyllSiO_{1.5})ₒ (PEGSiO_{1.5})ₚ]Σ#

3-Methacrylpropyl trimethoxysilane (248.35 g), 3,3,3-trifluoropropyl trimethoxysilane (218.25 g), PEG Silane (338 g) and Isooctyltrimethoxysilane (117.2 g) were added to a solubilizing solvent (3500 g) with stirring, After 10 minutes, tetramethyl ammonium hydroxide (12 g) was added and stirred for 48 hours. Citric acid (6.32 g) was added to the reaction and stirred for 1 hour. Solvent was removed and the liquid product was filtered. The yield of [(MethacrylpropyllSiO_{1.5})₂(i-OctylSiO_{1.5})₂(TrifuloropropyllSiO_{1.5})₂(PEGSiO_{1.5})₂]Σ# was 99%. The resulting product is a clear slightly yellow liquid with a viscosity of 388 mPa s at 25° C.

### Example of Rheological Property Differences Among Heteroleptic Cages, Homoleptic Cages, and Mixtures of Homoleptic Cages

Heteroleptic POSS compositions possess desirable rheological properties that are considerably different that those provided by homoleptic POSS or physical mixtures of homoleptic POSS. FIG. 4 shows the viscosity of examples of two homoleptic POSS compositions, a 50/50 mixture of the two homoleptic POSS compositions, and

First, a comparison of the viscosity of the homoleptic POSS EP0409 [(glycidylpropylSiO_{1.5})n]Σ8-14 relative to the viscosity of the homoleptic MA0735 [(methacrylpropylSiO_{1.5})n]Σ8-14 reveals that glycidyl homoleptic POSS cages are inherently higher in viscosity than methacryl homoleptic POSS cages. Next, a 50/50 physical blend of EP0409/MA0735 results in a viscosity that is close to the average value expected based on linear rules of mixtures.

In contrast, the heteroleptic POSS cage composition [(glycidylpropylSiO_{1.5})m(methacrylpropylSiO_{1.5})n]Σ8-14 where m and n are equivalent (i.e., 50/50) exhibits a unique synergistic viscosity that is significantly lower than the rule of mixture expectations. Thus, the 50/50 [(glycidylpropylSiO_{1.5})m(methacrylpropylSiO_{1.5})n]Σ8-14 heteroleptic would favorably be expected to behave as a more effective diluent additive in polymer formulations that obey linear rules of mixtures. This is a unique rheological attribute of the 50/50 glycidyl/methacryl heteroleptic POSS relative to equivalent physical mixtures of the homoleptic POSS systems.

### Examples of Hardness Differences Among Heteroleptic Cages, Homoleptic Cages, and Mixtures of Homoleptic Cages

A major advantage of heteroleptic POSS cages possessing two distinctively different types of reactive groups attached to the same POSS cage is that they allow for dual cure mechanisms. As used herein, “dual cure” means cured using any combination of two or more curing methods, such as free radical cure, cationic cure, thermal cure, radiation cure, and electron beam cure. Additional types of dual cure will also be envisioned by those skilled in the art. For example, the heteroleptic [(glycidylpropylSiO_{1.5})m(methacrylpropylSiO_{1.5})n]Σ8-14 where m and n are equivalent (i.e., 50/50) can be dual cured using free radical and cationic methods. This is advantageous in light of recent reports in the coating literature, which describe the combination of cationic and free radical cure methods to acrylic and epoxy physical mixture can achieve higher hardness values than achievable by each method applied independently.

To demonstrate the utility of the heteroleptic POSS cage in a dual cure method, a first sample of the [(glycidylpropylSiO_{1.5})m(methacrylpropylSiO_{1.5})n]Σ8-14 cage was cured using free radical methods and a second sample of the same POSS cage was cured using cationic methods. The first sample was cured using free radical methods by utilizing a 1 wt. % loading of the free radical initiators (Irgacure 1173 and Irgacure 184). Upon mixing with the heteroleptic POSS, the mixture was exposed to 3 seconds of UV light emitted from a Fusion D bulb. Free radicals generated by this initiator polymerized the acrylic groups on the heteroleptic POSS molecule. Cationic cure was carried out on the second sample using a 0.06 wt. % loading of the Syna 6976 and a 3 second exposure to emission from a Fusion D bulb. The acid (cation) generated from this initiator carried out polymerization of the epoxy group located on the heteroleptic POSS. A third sample of the same heteroleptic POSS composition was subjected to a dual cure method in the same manner by adding both types of the above-listed initiators at the respective amounts to the heteroleptic POSS composition, and exposing the mixture to emission from a Fusion D bulb for 3 seconds.

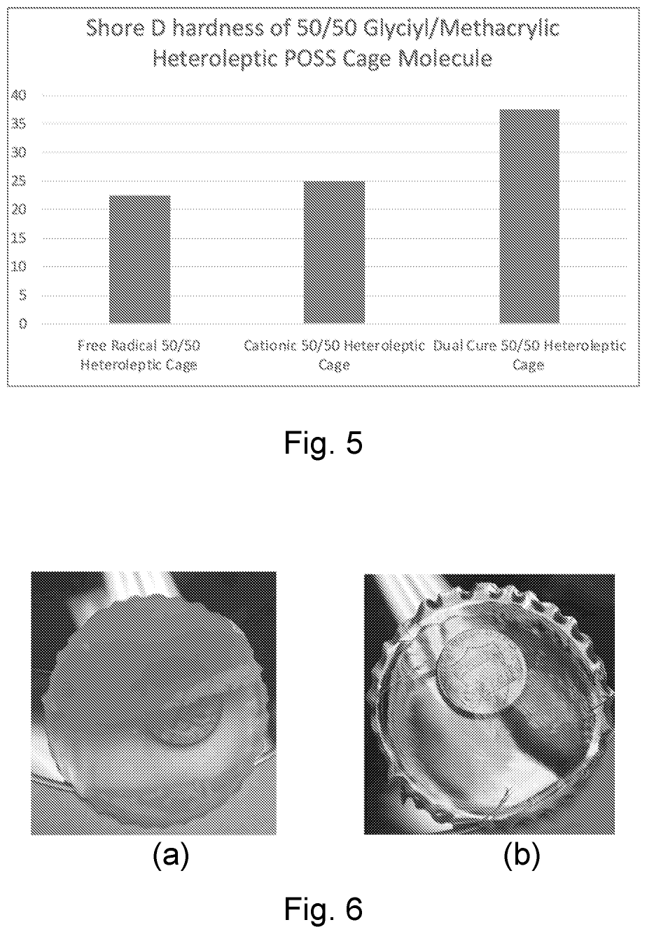

Hardness testing was carried out using a manual Shore D tester on 4 mm thick cured plaques of the three samples. The hardness findings are shown in FIG. 5. The heteroleptic POSS containing acrylic/epoxy groups on the same molecule show synergistic enhancement of hardness through use of dual cure. Furthermore, it is important to note that hardness values for 50/50 physical mixtures of glycidyl and methacryl homoleptic POSS cured by either free radical or cationic methods were <5 Shore D and their surfaces were sticky due to the unreacted homoleptic component. Furthermore, when physical mixtures of homoleptic POSS systems are dual cured this necessarily results in a solid that contains two different polymers because each is cured independently. However, when a heteroleptic POSS such as that containing acrylic/epoxy is dual cured, a single polymer results due to the connectivity through the POSS cage. Consequently, these two approaches result in a cured material that can have different mechanical and physical properties.

Finally, heteroleptic POSS cages possessing both glycidyl and acrylic groups can also be cured using thermal methods or a combination of thermal and UV methods. In such scenarios, the 50/50 heteroleptic POSS continues to provide for the opportunity to dual cure relative to the types of reactive groups on the cage. Again, literature findings report the application of dual cure (thermal+UV) is able to provide enhancement of physical properties. Based on the favorable dual cure synergy discovered above for epoxy/acrylic heteroleptic POSS under UV (cationic+free radical) conditions, we logically anticipate such synergies for heteroleptic POSS in all other types of dual cure scenarios.

### Example of Optical Property Differences Among Heteroleptic Cages, Homoleptic Cages, and Mixtures of Homoleptic Cages

It is important to recognize that physical mixtures of monomers can undergo phase separation upon cure. Phase separation is the creation of segregated domains of one type of polymer or monomer. In turn, phase separation causes a loss of optical properties such a transmittance, clarity, haze, gloss, mechanical, electrical, and other undesirable characteristics. The issue is well known and documented in polymer and coatings science.

Molecularly unifying different types of organic groups on the same molecule results in heteroleptic POSS cages that are resistant to phase separation during polymerization. Thus, heteroleptic POSS cages are able to reproducibly render high quality optical properties upon cure.

To illustrate the benefits of heteroleptic POSS toward optical properties, a comparative set of polymerizations was carried out using a physical mixture of equal amounts of glycidyl and methacryl homoleptic POSS (EP0409 and MA0735) and a 50/50 heteroleptic POSS [(glycidylpropylSiO_{1.5})m(methacrylpropylSiO_{1.5})n]Σ8-14. FIG. 6 is a comparison of the appearance of free radial cured plaques for (a) a 50/50 mixture of glycidyl EP0409 homoleptic POSS and methacryl MA0735 homoleptic POSS, and (b) a 50/50 glycidyl/methacryl heteroleptic POSS.

The physical blend of the methacryl homoleptic POSS and the glycidyl homoleptic POSS produced an opaque plaque likely due to the inability of the glycidyl (epoxy) component to polymerize under free radical conditions. In contrast, the 50/50 heteroleptic POSS remained optically clear despite the fact that the glycidyl groups on the molecule cannot partake in free radical polymerization.

In this example, the optical clarity of the heteroleptic POSS is of great advantage as is the fact that it contains unreacted epoxy groups. which can be of further utility for adhesion, dispersion, or alteration of surface energy. This point also illustrates the unique capability of heteroleptic POSS to provide an envelope of desirable physical characteristics in addition to the crosslinking function utilized in this example.

### Examples of Compatibilization and Dispersion by Cages

The combination of different types of organic groups on a POSS heteroleptic cage also enables these additives to be useful as compatiblizers. A compatibilizer is any substance that enables the miscibility, interfacial compatibility, dispersion, or suspension between two or more substances that would otherwise phase separate.

In addition to the molecular combination of multiple different types of organic groups on a heteroleptic POSS, the compatibilization effect is further enhanced by the volume and surface area contributions from POSS systems. These attributes have been recognized in the literature, but were not previously conceived in combination with heteroleptic POSS compositions.

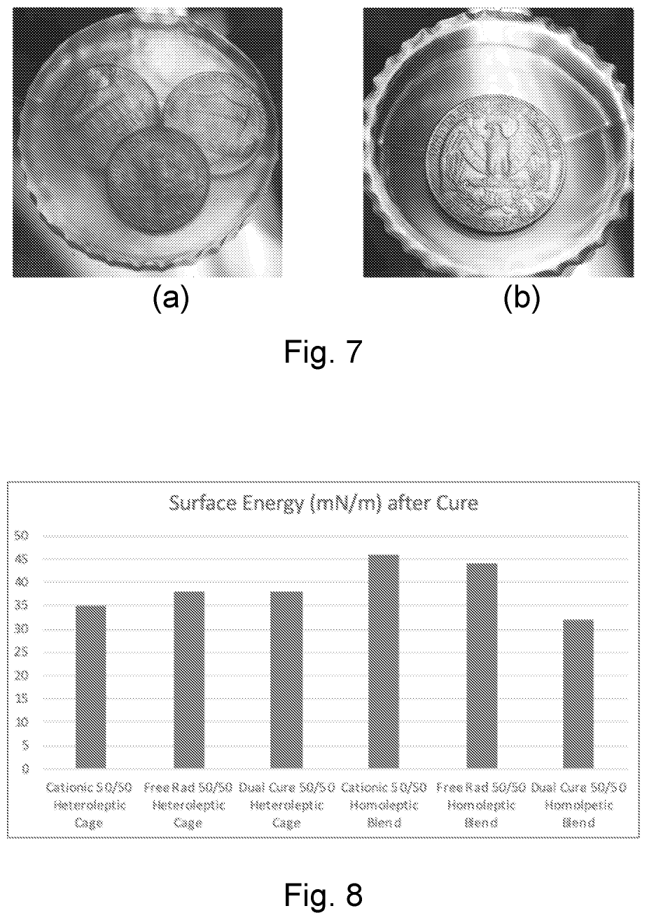

To illustrate the compatibilization effect of heteroleptic POSS, a comparative experiment was carried out. Specifically, a 70/30 physical mixture of glycidyl homoleptic POSS and methacryl homoleptic POSS was mixed and cured cationically. As shown in image (a) of FIG. 7, this mixture formed hazy plaque due to the inability of the methacrylate component to cure under this condition. To the same 70/30 physical mixture of glycidyl homoleptic POSS and methacryl homoleptic POSS, an equal amount of the 50/50 glycidyl/methacryl heteroleptic POSS was added and the resulting mixture was cured cationically using the same method. As shown in image (b) of FIG. 7, the plaque resulting from the mixture including the heteroleptic POSS is optically clear despite the fact that methacryl groups are still present and were not activated by the cationic cure method.

In this example, the optical clarity and ability of the heteroleptic POSS to compatibilize the otherwise incompatible methacryl component (MA0735) is of great advantage as the plaque contains unreacted methacryl groups, which can be of further utility for adhesion, alteration of surface energy, or for secondary modification. This point again illustrates the unique capability of heteroleptic POSS to provide an envelope of desirable physical characteristics in addition to the crosslinking and compatibilization functions utilized in this example.

### Examples of Surface Energy Differences Among Heteroleptic Cages, Homoleptic Cages, and Mixtures of Homoleptic Cages

The multiple types of organic groups on heteroleptic POSS cages in combination with their ability to be reacted or free affords a valuable and unique opportunity to adjust surface energy. In this case, heterolepticity provides an important advantage over physical blends of such organic groups. The advantage lies in the elimination or at least the severe restriction of component migration from the cured material. The migration of plasticizers, emulsifier, humectants, etc. is well known from physical mixtures. The covalent bond between the organic groups and the heteroleptic POSS cage core prevents complete migration and depletion of such organics from the molecule.

The surface energy of materials is an important factor in coatings, adhesives, and biological interactions. For example, high surface energy results from polar groups (e.g., PEG, epoxy, amide, alcohol groups) and is highly desired to promote adhesion to other polar substances. Alternately, low surface energy results from low polarity groups (e.g. fluoro, silicone, and hydrocarbon groups) and is highly desired for non-marking surfaces, lubricants, and moisture repellency.

Heteroleptic POSS provides tighter consistency of surface energy because of their molecular nature. To illustrate this advantage, the surface energy of the 50/50 glycidyl/methacryl heteroleptic POSS was measured after cationic cure, free radical cure, and dual cure. The surface energy of a 50/50 mixture of glycidyl homoleptic POSS and methacryl homoleptic POSS was also measured after cationic cure, free radical cure, and dual cure. Each of these measurements are shown in FIG. 8. The range of surface energy difference for heteroleptic POSS was only 3 dynes. The range of variance for the physical mixture of homoleptic POSS was 14 dynes. Therefore, the precision of heteroleptic POSS in controlling surface energy is significantly improved over physical mixtures of homoleptic POSS.

The ability of heteroleptic POSS to control and maintain surface energy over time can directly improve the shelf-life, durability, and reliability of surfaces which in turn can improve the economics and value of a wide variety of items of commerce in the aforementioned areas.

### Examples of Gloss Control for Heteroleptic Cages and Mixtures Thereof

Similarly, the multiple types of organic groups on heteroleptic POSS cages in combination with their ability to be reacted or free affords a valuable and unique opportunity to adjust gloss and lubricity. The same advantage for heteroleptic POSS lies in the elimination or at least the severe restriction of component migration from the cured material. The level of surface gloss is an important factor in coatings, paints, personal care products, and formed parts. Heteroleptic POSS provide tighter consistency gloss values because of their molecular nature. Experimental results showed that the addition of heteroleptic POSS to UV cured urethane acrylate resins cast at 25 micron thickness resulted in an increase of glass values.

### Examples of Dispersion of Carbon, Silica, Polymer Particle, and Metal Oxides for Heteroleptic Cages

In a similar manner to the ability of heteroleptic POSS to serve as compatibilizers, they are also of great utility as dispersants. Here again their advantage stems for the molecular union of different types of organic groups to a molecular core and the envelope of properties provided. In the case where dispersion and crosslinking are desired, heteroleptic POSS comprised of R′ with a polymerizable functionality and R″ with a dispersion functionality may be used. For example, a suitable composition for this scenario is a heteroleptic POSS with methacrylate and PEG in which the methacrylate can serve as a crosslinker and the PEG can serve as a dispersant. To illustrate the advantages of heteroleptic POSS, a series of silica and carbon dispersions were prepared.

Silica dispersions containing 40 wt % of colloidal nanosilica (10-15 nm diameter) were prepared with homoleptic POSS and heteroleptic POSS to assess the relative effects of particle dispersion on rheological properties. At room temperature, the 40 wt % silica dispersed into homoleptic EPPOSS [(GlycidylpropylSiO_{1.5})₈]Σ#, homoleptic MAPOSS [(MethacrylpropylSiO_{1.5})₈]Σ#, and heteroleptic EPMAPOSS [(GlycidylpropylSiO_{1.5})₄(MethacrylpropylSiO_{1.5})₄]Σ# resulted in optically clear solids. Therefore, rheology measurements were carried out a 50° C. at which point the solids became liquid. Table 3 shows the viscosity of these two homoleptic POSS samples and the heteroleptic sample.

TABLE 3
Dispersion response to heteroleptic POSS and homoleptic POSS.

| | Silica + POSS |
|---|---|
| Silica + POSS Dispersions | Viscosity |
| @ 50° C. | mPa s |
| EPPOSS (homoleptic) | 23.74 |
| MAPOSS (homoleptic) | 0.2839 |
| EPMA POSS (heteroleptic) | 0.0005621 |

The heteroleptic EPMAPOSS [(GlycidylpropylSiO_{1.5})₄(MethacrylpropylSiO_{1.5})₄]Σ# silica dispersion exhibits a considerably lower melt viscosity. Thus in this case, the heteroleptic POSS can be utilized as a rheological diluent and is also capable of crosslinking through the reactive methacrylate and glycidyl groups. A similar comparison was made for silica dispersions made from the homoleptic PEG POSS [(PEGSiO_{1.5})₈]Σ# and the heteroleptic EPPEG POSS [(GlycidylpropylSiO_{1.5})₅(PEGSiO_{1.5})₃]Σ# and heteroleptic MAPEG POSS [(MethacrylpropylSiO_{1.5})₅(PEGSiO_{1.5})₃]Σ#. In contrast, all PEG containing heteroleptic POSS compositions in combination with 40 wt % silica were liquids at room temperature (˜25° C.).

In the case of carbon nanotube (CNT) dispersions, a 1 wt % loading of 5 micron length single walled tubes were added to homoleptic POSS and heteroleptic POSS. As shown in Table 4, the viscosity of the heteroleptic EPMA POSS [(GlycidylpropylSiO_{1.5})₄(MethacrylpropylSiO_{1.5})₄]Σ# and the heteroleptic EPPEG POSS [(GlycidylpropylSiO_{1.5})₅(PEGSiO_{1.5})₃]Σ# was less than the viscosity of the homoleptic EPPOSS [(GlycidylpropylSiO_{1.5})₈]₈Σ#.

TABLE 4
Dispersion response to heteroleptic and homoleptic combinations.

| | CNT + POSS |
|---|---|
| CNT + POSS Dispersions | Viscosity |
| @ 50° C. | mPa s |
| EPPOSS (homoleptic) | 13,700 |
| EPMA POSS (heteroleptic) | 4,282 |
| EPPEG POSS (heteroleptic) | 822.6 |

Relative to the high viscosity value of the homoleptic EPPOSS+CNT system, the incorporation of either glycidyl or PEG groups into a heteroleptic EPPOSS results in superior wet-out, dispersion, and diluency effects as evidenced by the reduction of viscosity.

In both the silica and CNT systems, the ability to crosslink the POSS dispersion agent prevents the migration of the dispersant to the surface after cure. The prevention of surface migration is a major advantage for heteroleptic POSS over conventional dispersants.

Note that in some instances heteroleptic POSS with nonreacted reactive groups (R′) may also function as dispersants. In particular, epoxy (glycidyl) groups are known to have such capacity.

### Heteroleptic POSS Plasticization Additives

In a similar manner to dispersion, heteroleptic POSS provide a unique ability to plasticize a material before and after cure. In this case, the plasticization functionality is primarily associated with R′″ groups such as long chain alkyl, PEG, or fluorinated compositions. However, non-reacted R′ groups can also serve as plasticizers and this statement may also apply to R″ given proper circumstances.

The primary advantage for heteroleptic POSS in a plasticization role is the reduction or elimination of migration. Unlike traditional plasticizers, heteroleptic POSS cage contain groups suitable for polymerization or grafting into the final polymer. Consequently, this solves the problem of plasticizer migration to the surface of the final polymer as a contaminant.

### Heteroleptic POSS Emulsion Additives

Heteroleptic POSS molecules containing a combination of polar and nonpolar organic groups that are well suited for use in emulsions. While some prior art describes the use of homoleptic POSS and one monoheteroleptic POSS in emulsions, there are no reports of homoleptic nor heteroleptic POSS serving as emulsification agents.

The primary advantage for heteroleptic POSS in an emulsification role is the advantage of surface area and volume provided by the POSS molecule. Emulsions are highly surface area and volume dependent and typically require significant amounts of surfactant. The surfactant is necessarily retained with delivery of the final product. Consequently, issues such as surfactant migration, plasticization, and alteration of surface energy often plague emulsion delivered coatings. Heteroleptic POSS uniquely offers a large surface area and volume, which can reduce the amount of surfactant usage. Also, when heteroleptic POSS contains polymerizable groups in combination with emulsification groups, these agents can be polymerized into the polymer in a nondetrimental manner that reduces or eliminates migration of the emulsification agent.

Any range of numeric values disclosed herein includes any subrange therein. While preferred embodiments have been described, it is to be understood that the embodiments are illustrative only and that the scope of the invention is to be defined solely by the appended claims when accorded a full range of equivalents, many variations and modifications naturally occurring to those skilled in the art from a review hereof.

1-32. (canceled)

33. A method of producing a heteroleptic polyhedral oligomeric silsesquioxane (POSS) in a single vessel, the method comprising:
a) charging a reaction vessel with a first solvent, organosilane, water, and base at concentrations and holding for a time period sufficient to allow for POSS cage formation;
b) adding a suitable acid to quench the POSS cage formation process through formation of a salt;
c) separating the salt from a reaction mixture, wherein the salt is separated from a POSS product;
d) removing the first solvent from the reaction vessel; and
e) collecting the POSS product from the reaction vessel.

34. The method of claim 33, wherein the POSS product is a homoleptic POSS or a heteroleptic POSS in a clear and colorless or pale yellow form, and wherein the POSS product is free from traces of salt, acid, or base.

35. The method of claim 33, wherein the method does not require isolation of a POSS intermediate.

36. The method of claim 33, wherein the concentration of organosilane in the reaction vessel in step (a) is 6-8 moles/liter.

37. The method of claim 36, wherein the concentration of organosilane in the reaction vessel in step (a) is 1-2 moles/liter.

38. The method of claim 33, wherein step (a) further comprises heating the reaction vessel to a temperature of 20-120° while holding for the time period.

39. The method of claim 38, wherein step (a) further comprises heating the reaction vessel to a temperature of 24-60° while holding for the time period.

40. The method of claim 33, wherein the suitable acid added in step (b) is a soluble acid, wherein the salt formed in step (b) is a soluble salt;

41. The method of claim 40 wherein the suitable acid added in step (b) is a soluble acid, wherein the salt formed in step (b) is a soluble salt; and wherein in step (c) the separation of the salt from the reaction mixture further comprises:
i) adding a non-POSS solvent and a POSS solvent to produce a liquid-liquid phase separation to separate the soluble salt from the POSS product, wherein the non-POSS solvent solubilizes the soluble salt and the POSS solvent solubilizes the POSS product; and
ii) removing the soluble salt and non-POSS solvent phase from the bottom of the reaction vessel.

42. The method of claim 41, wherein the non-POSS solvent is water.

43. The method of claim 41, wherein traces of soluble acid, soluble salt, and base are removed by the non-POSS solvent.

44. The method of claim 33, wherein the suitable acid added in step (b) is an insoluble acid, and wherein the salt formed in step (b) is an insoluble salt.

45. The method of claim 44, wherein in step (c) the separation of the salt from the reaction mixture further comprises:
i) filtering or decanting the insoluble salt from the reaction mixture and returning the filtered or decanted liquid reaction mixture to the reaction vessel.

46. A heteroleptic polyhedral oligomeric silsesquioxane (POSS) composition produced by a process comprising: the method comprising:
a) charging a reaction vessel with a first solvent, organosilane, water, and base;
b) adding a suitable acid to quench the POSS cage formation process through formation of a salt;
c) separating the salt from a reaction mixture, wherein the salt is separated from a POSS product; and
d) removing the first solvent from the reaction vessel.

47. The heteroleptic POSS composition of claim 46, wherein the suitable acid added in step (b) is a soluble acid, wherein the salt formed in step (b) is a soluble salt; and wherein in step (c) the separation of the salt from the reaction mixture further comprises:
i) adding a non-POSS solvent and a POSS solvent to produce a liquid-liquid phase separation to separate the soluble salt from the POSS product, wherein the non-POSS solvent solubilizes the soluble salt and the POSS solvent solubilizes the POSS product; and
ii) removing the soluble salt and non-POSS solvent phase from the bottom of the reaction vessel.

48. The heteroleptic POSS composition of claim 47, wherein the heteroleptic POSS composition comprises a distribution of POSS cage sizes and a distribution of organic groups from organosilanes.

49. The heteroleptic POSS composition of claim 47, wherein the organosilanes in step (a) are trimethoxy, triethoxy, or triacetoxy organosilanes.

50. The heteroleptic POSS composition of claim 46, wherein wherein the suitable acid added in step (b) is an insoluble acid, wherein the salt formed in step (b) is an insoluble salt; and wherein in step (c) the separation of the salt from the reaction mixture further comprises:
i) filtering or decanting the insoluble salt from the reaction mixture and returning the filtered or decanted liquid reaction mixture to the reaction vessel.

51. The heteroleptic POSS composition of claim 50, wherein the heteroleptic POSS composition comprises two or more organic groups from two or more organosilanes, wherein the organic groups are classified as reactive R′ groups, special purpose R″ groups, nonreactive R′ groups, or a combination thereof.

52. The heteroleptic POSS composition of claim 50, wherein the organosilanes in step (a) are trimethoxy, triethoxy, or triacetoxy organosilanes.
